(19) United States
(12) Patent Application Publication
(10) Pub. No.: US 2026/0361259 A1
(43) Pub. Date: Nov. 12, 2026

(54) SOLAR PANEL SUPPORT STRUCTURE WITH GROUND ANCHOR ALIGNMENT MECHANISM

(71) Applicant: APA SOLAR, LLC, Ridgeville Corners, OH (US)

(72) Inventors: Shawn Jeremy Ramey, Ney, OH (US); Joseph Von Deylen, Whitehouse, OH (US); Erik Steven Shinabery, Bryan, OH (US); Josh Von Deylen, Bryan, OH (US)

(21) Appl. No.: 19/674,931

(22) Filed: May 12, 2026

Related U.S. Application Data
(60) Provisional application No. 63/804,289, filed on May 12, 2025.

(51) Int. Cl. H02S 20/10

(52) U.S. Cl. CPC H02S 20/10

(57) ABSTRACT

A support structure for a solar panel includes a mounting bracket for supporting a torque tube supporting the solar panel. The support structure also includes a leg extending between a first end and a second end with the first end coupled to the mounting bracket. An anchor is seated in the ground and includes an attachment end protruding above the ground. The support structure further includes an alignment mechanism coupled to the second end of the leg and the attachment end of the anchor. The alignment mechanism allows for adjustment of the second end of the leg along at least one axis generally parallel to the ground.

### CROSS-REFERENCE TO RELATED APPLICATIONS

This application claims the benefit of U.S. Provisional Application No. 63/804,289, filed on May 12, 2025. The entire disclosure of the above application is incorporated herein by reference.

### FIELD

The present technology relates to support structures for solar panels.

### INTRODUCTION

This section provides background information related to the present disclosure which is not necessarily prior art.

Solar tracking systems rely on precisely aligned torque tubes to function properly. In certain examples, manufacturers specify alignment tolerances for the torque tubes of less than three degrees. Ground screws may serve as foundational anchors for the torque tubes of the tracking systems. During installation, ground screws can encounter subsurface obstructions or variations in soil conditions that affect their final positioning. When ground screws deviate from their intended alignment, even by a few inches across typical spans of 36 to 60 inches, the resulting misalignment of the torque tubes can compromise the entire solar tracking system.

The installation process for ground screws presents inherent challenges in achieving and maintaining precise alignment of the torque tubes. As ground screws are driven into the earth, they may tilt or shift slightly from their intended position due to underground obstacles or soil inconsistencies. These minor deviations in ground screw placement can create significant alignment issues for the supported torque tubes. The foundation alignment of solar tracking systems depends heavily on the precise positioning of their ground screws. When ground screws are not perfectly aligned, the resulting angular discrepancies can prevent the tracking system from operating within manufacturer specifications.

Accordingly, there is a continuing need for an adjustment mechanism that can compensate for ground screw misalignment while maintaining proper support for solar tracking systems.

### SUMMARY

In concordance with the instant disclosure, an alignment mechanism for a solar panel support structure has surprisingly been discovered.

The present technology includes articles of manufacture, systems, and processes that relate to solar panel support structures.

In one embodiment, a support structure for a torque tube supporting a solar panel includes a mounting bracket for supporting the solar panel. The support structure also includes a leg extending between a first end and a second end with the first end coupled to the mounting bracket. An anchor is seated in the ground and includes an attachment end protruding above the ground. The support structure further includes an alignment mechanism coupled to the second end of the leg and the attachment end of the anchor. The alignment mechanism allows for adjustment of the second end of the leg along at least one axis generally parallel to the ground.

In another embodiment, an alignment mechanism for alignment of a support structure of a solar panel with a ground anchor is disclosed. The support structure includes a leg. The alignment mechanism includes a top bracket configured to be coupled to the leg. A bottom bracket is configured to be coupled to the ground anchor. The top bracket defines a first slot. A first bolt is disposed through the first slot and connectable to the leg for allowing the leg to be adjusted along a first axis. The top bracket defines a second slot and the bottom bracket defines third slot. A second bolt is disposed through the second slot and the third slot, allowing the leg to be adjusted along a second axis generally perpendicular to the first axis.

In a further embodiment, a method of installing an alignment mechanism to compensate for misalignment of a ground anchor may include securing a bottom bracket to an attachment end of the anchor, the bottom bracket having a central panel and side panels extending from opposite sides of the central panel. The method may further include positioning a top bracket against the bottom bracket with the central panel of the top bracket abutting the central panel of the bottom bracket and with the side panels of the top bracket and the side panels of the bottom bracket extending in opposite directions away from one another. The method may also include connecting a second end of a leg to the top bracket through at least one slot defined by the top bracket and adjusting a position of the leg along at least one axis generally parallel to the ground to achieve yaw alignment of the leg relative to the anchor. The method may further include tightening all fasteners to secure the alignment mechanism in the aligned position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side elevational view of a support structure for a solar panel according an exemplary embodiment;

FIG. 2 is a perspective view of the support structure according to an exemplary embodiment;

FIG. 3 is an enlarged perspective view of an adjustment mechanism of the support structure shown in FIG. 2 according to an exemplary embodiment;

FIG. 4 is a perspective view of a top bracket of the adjustment mechanism according to an exemplary embodiment;

FIG. 5 is a perspective view of a bottom bracket of the adjustment mechanism according to an exemplary embodiment;

FIG. 6 is a side elevational view of the adjustment mechanism according to an exemplary embodiment;

FIG. 7 is a perspective view of the top and bottom brackets according to an exemplary embodiment; and

FIG. 8 is a perspective view of multiple adjustment mechanisms connected with a brace according to an exemplary embodiment;

FIG. 9 is a flowchart illustrating a method 900 of installing the alignment mechanism according to an exemplary embodiment;

FIG. 10 is a perspective view of the adjustment mechanism according to another exemplary embodiment; and

FIG. 11 is a differing perspective view of the adjustment mechanism of FIG. 10.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves solar tracker foundation systems by providing an alignment mechanism that compensates for ground anchor misalignment through independently adjustable brackets. The alignment mechanism enables lateral and rotational adjustment, referred to herein as yaw adjustment, to achieve proper torque tube alignment as required by manufacturers of solar panels and solar panel systems. In standard configurations, the alignment mechanism provides yaw adjustment of up to about three degrees. In installations where greater misalignment is encountered, enlarged bracket assemblies having extended slots may be employed to provide yaw adjustment of up to about five degrees.

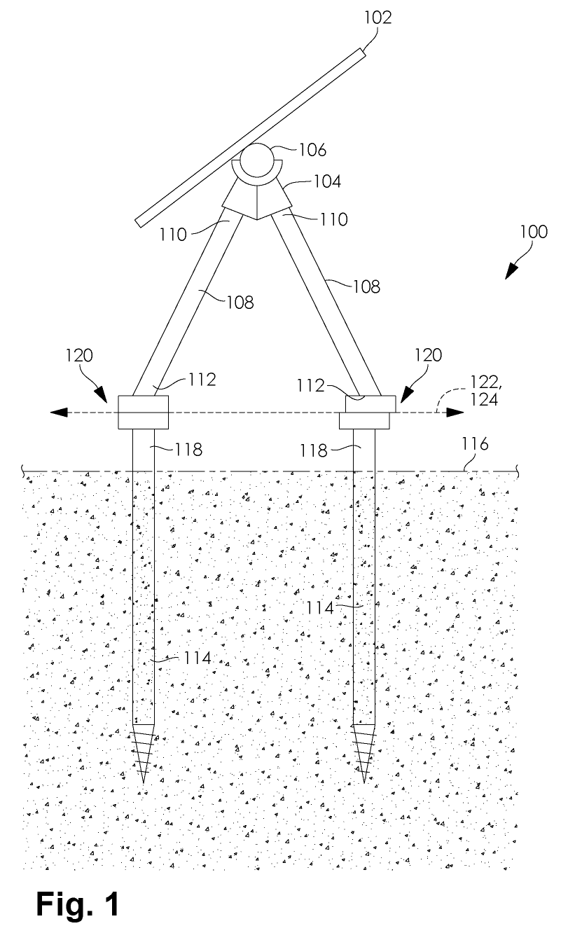

FIG. 1 illustrates a support structure 100 for a solar panel 102 according to an exemplary embodiment. The various components of the support structure 100 described herein may be formed of metal, such as steel, aluminum, etc. However, it should be appreciated that the various components of the support structure 100 may be formed of other materials, such as plastics, fiberglass, carbon fiber, or other suitable materials for intended and/or anticipated environmental exposure.

The support structure 100 may include a mounting bracket 104 for supporting the solar panel 102. More particularly, in the embodiment shown in FIG. 1, the mounting bracket 104 supports a torque tube 106. The torque tube 106, in turn, supports the solar panel 102, as is well known and customary in the art of solar tracking systems.

The support structure 100 includes at least one leg 108 coupled to the mounting bracket for supporting the mounting bracket 104, and thus the torque tube 106 and the solar panel 102. In the embodiment shown in FIG. 1, a pair of legs 108 are shown. Each leg 108 extends between a first end 110 and a second end 112. The first end 112 may be coupled to the mounting bracket 104. The legs 108 may be formed as tubes, i.e., having a generally hollow structure. The tubes may have a circular or rectangular cross-section as shown in the various embodiments shown in the figures. Of course, the legs 108 may be formed in various other shapes as appreciated by those of ordinary skill in the art.

FIG. 1 also illustrates an anchor 114 set in the ground 116. Specifically, FIG. 1 shows a pair of anchors 114. It should be appreciated that four anchors 114 may be utilized to support one torque tube 106. The torque tube 106 may then support one or more solar panels 102. In some embodiments, the anchors 114 may be implemented by a ground screw formed in or coupled to a distal end of the anchors 114. However, it should be appreciated that other anchoring hardware may be utilized to implement the anchor 114. Each anchor 114 may include an attachment end 118 protruding above the ground 116.

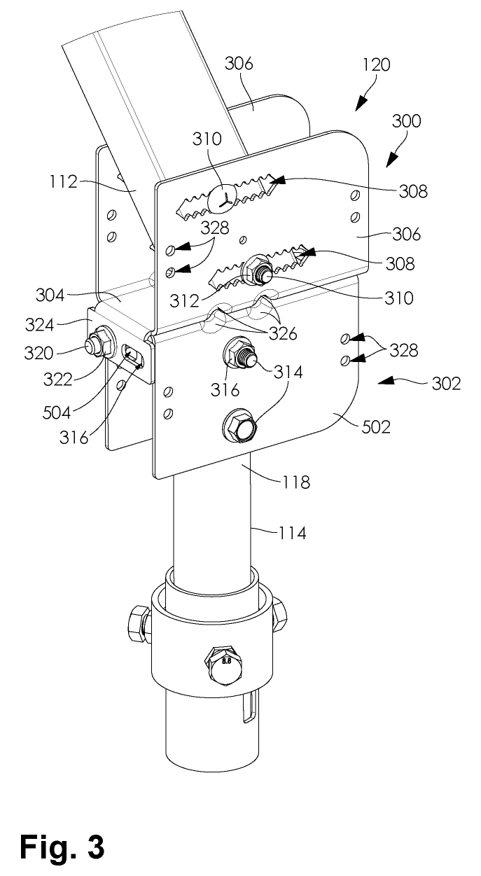

As shown in FIGS. 3-7, a top bracket 300 and a bottom bracket 302 may each be formed as a single piece through stamping and bending processes, wherein a central panel 304, 500 and side panels 306, 502 are formed from a single sheet of material with the side panels 306, 502 bent generally perpendicular to the central panel 304, 500 to produce a generally U-shaped configuration. Alternatively, the top bracket 300 and the bottom bracket 302 may each be assembled from multiple panels connected with fasteners. In either construction, the resulting bracket presents the central panel 304, 500 at the base and the side panels 306, 502 extending perpendicularly therefrom. The brackets 300, 302 may be formed of metal, such as steel or aluminum, selected based on the structural loading requirements and environmental conditions of the particular solar tracking installation.

In the event that the second end 112 of the leg 108 is not precisely aligned with the attachment end 118 of the anchor 114, an alignment mechanism 120 may be utilized. The alignment mechanism 120 can be coupled to the second end 112 of the leg 108 and the attachment end 118 of the anchor 114 and allows for adjustment of the second end 112 of the leg along at least one of the axis 122, 124 generally parallel to a surface of the ground 116.

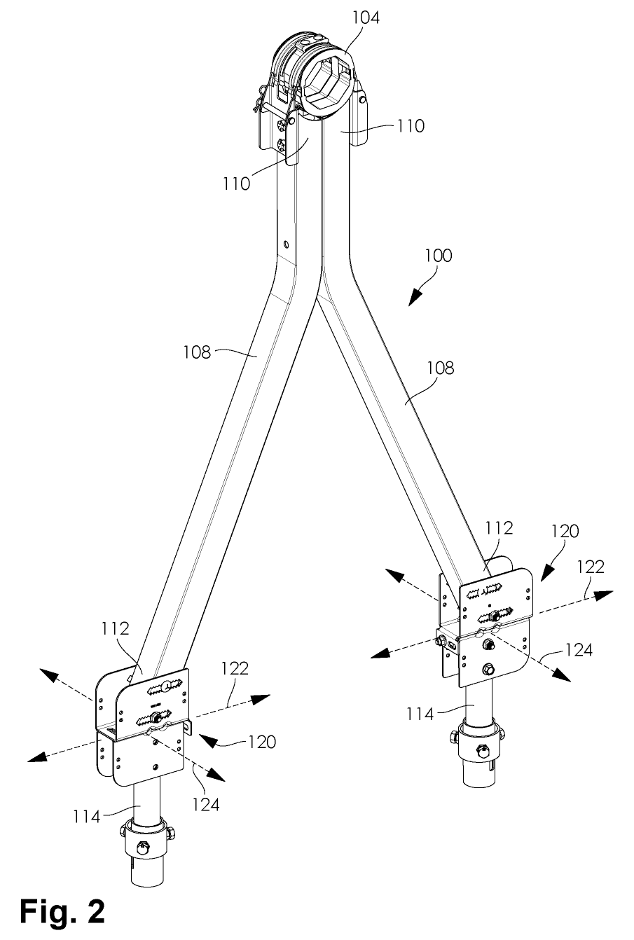

Referring now to FIG. 2, the alignment mechanism 120 of this exemplary embodiment allows for movement of the second end 112 of the leg 108 along a first axis 122 and a second axis 124. The first axis 122 and the second axis 124 are generally perpendicular to one another. When installed, the first and second axes 122, 124 are generally parallel to a surface of the ground 116. As such, the second end 112 of the leg 108 may be moved in multiple directions to ensure alignment with the attachment end 118 of the anchor 114

FIG. 3 shows an exemplary embodiment of the alignment mechanism 120 in greater detail. The alignment mechanism 120 may include the top bracket 300 and the bottom bracket 302. The top bracket 300 is configured to be coupled to the leg 108. The bottom bracket 302 is configured to be coupled to the ground anchor 114. The two brackets 300, 302 engage one another as described in greater detail below.

The top bracket 300 may include a central panel 304 and a side panel 306. The side panel 306 may extend generally perpendicularly from the central panel 304. In the embodiment shown in FIG. 3, a pair of side panels 306 are utilized, with each side panel 306 extending from opposite sides of the central panel 304. Each side panel 306 may extend generally perpendicular to the ground 116 when installed.

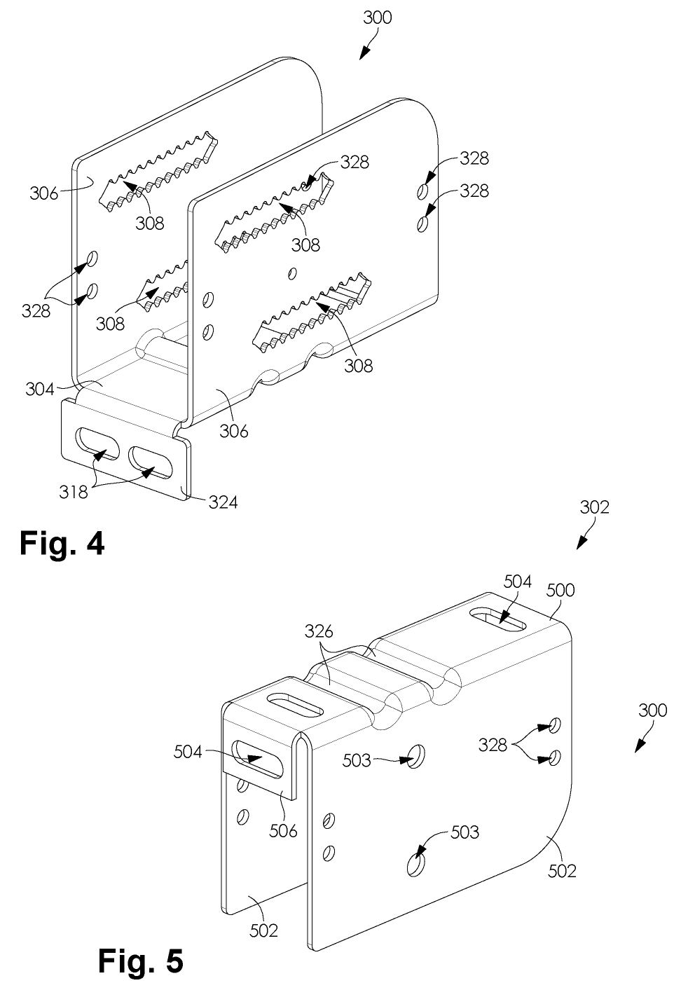

The top bracket 300 may define a slot 308 to accommodate a bolt 310 and allow the bolt 310 to slide along the slot 308. In the exemplary embodiment shown in FIGS. 3 and 4, a pair of slots 308 are defined by each side panel 306. Each slot 308 on one side panel 306 is aligned with a corresponding slot 308 on the other side panel 306. Holes (not visible) are defined by the leg 108 such that the bolt 310 may pass through one of the slots 308, through the holes, and through the corresponding slot 308 on the other side panel 306. Each bolt 310 may include threads and a nut 312 may be utilized to secure the bolt 310. With the nut 312 loose, the bolts 310 may slide along the slot 308, thus allowing the second end 112 of the leg 108 to be adjusted along the first axis 122.

The slot 308 may include a plurality of serrations (not numbered), i.e., teeth. The bolt 310 may be a carriage bolt having a portion (not shown) with a generally rectangular cross section. As such, the portion of the bolt 310 with the generally rectangular cross-section may engage with the serrations of the slot 308 to assist in securing the bolt 310 in place along the length of the slot 308.

The engagement of the carriage bolt with the serrations of the slot 308 provides a series of discrete, incremental holding positions along the length of the slot 308, enabling precise fore-and-aft and angular positioning of the second end 112 of the leg 108 relative to the top bracket 300. As the carriage bolt is positioned along the slot 308, the generally rectangular cross-section portion of the bolt engages successive serrations, resisting unintended movement of the leg 108 prior to final tightening of the nut 312. This serration engagement supplements the lateral adjustment provided by a second slot 318 and a third slot 504, thereby providing additional yaw adjustment capability when the slots 308, 318, 505 are used in combination.

It should be appreciated that other configurations of the top bracket 300, slot 308, and bolt 310 can be implemented. For example, the bolt 310 could be securely affixed (e.g., welded) to the leg 108 and pass through the slot 308 such that the position of the second end 112 of the leg 108 may be adjusted and secured with a nut. In another example, the leg 108 may include a threaded interface (e.g., a welded nut) to accommodate the bolt 310, thus allowing the bolt 310, and the leg 108, to be adjusted until secured. In another example, the slot 308 defined by the top bracket 300 may be alternatively implemented by a series of holes to accommodate the bolt 310 at different positions. These configurations are not shown in the figures but will be appreciated by those of ordinary skill in the art.

The alignment mechanism 120 may be installed as follows. The bottom bracket 302 can first be secured to the attachment end 118 of the anchor 114 by aligning the apertures of the side panels 502 of the bottom bracket 302 with a corresponding aperture formed through the attachment end 118 of the anchor 114. The bolt 314 can then inserted through the aligned apertures and secured with the nut 316 to fix the bottom bracket 302 to the anchor 114.

The top bracket 300 can then be positioned against the bottom bracket 302 with the central panel 304 of the top bracket 300 abutting the central panel 500 of the bottom bracket 302 and with the side panels 306 of the top bracket 300 and the side panels 502 of the bottom bracket 302 extending in opposite directions away from one another. The second slot 318 of the top bracket 300 and the third slot 504 of the bottom bracket 302 can be aligned with one another, and a bolt 320 can be inserted through the aligned slots 318, 504 and loosely secured with a nut 322 to permit lateral adjustment of the top bracket 300 relative to the bottom bracket 302 along the second axis 124.

The second end 112 of the leg 108 can then positioned within the side panels 306 of the top bracket 300 with the holes defined by the leg 108 aligned with the slots 308 of the side panels 306. The bolt 310 is inserted through one slot 308, through the holes in the leg 108, and through the corresponding slot 308 on the opposite side panel 306, and loosely secured with the nut 312 to permit adjustment of the leg 108 along the first axis 122.

With the bolts 310, 320 loosely secured, the position of the second end 112 of the leg 108 is adjusted along the first axis 122 and the second axis 124 to achieve proper yaw alignment of the leg 108 and the mounting bracket 104 relative to the anchor 114. The bolt 310 can engage with a desired serration of the slot 308 to achieve the desired fore-and-aft and angular position of the leg 108. Once proper alignment is confirmed, all fasteners can be fully tightened to secure the alignment mechanism 120 in the aligned position.

In the exemplary embodiments shown in FIGS. 2-7, the bottom bracket 302 may include a central panel 500, as best seen in FIG. 5. The bottom bracket 302 may include one or more side panels 502. In the illustrated embodiments, the bottom bracket 302 includes a pair of side panels 502, each extending generally perpendicular from opposite ends of the central panel 500. The bottom bracket 302 may be coupled to the anchor 114. In the illustrated embodiments, each side panel 502 defines includes a hole 503. Referring again to FIG. 3, a bolt 314 may be disposed through the holes 503 of the side panels 502 and through a hole (not visible) defined by the anchor 114. A nut 316 may be utilized to secure the bolt 314, and thus the anchor 114 to the bottom bracket 302.

The top bracket 300 and the bottom bracket 302 slidably engage one another to allow movement of the leg 108 along the second axis 124. In the illustrated embodiments, the central panel 304 of the top bracket 300 abuts the central panel 500 of the bottom bracket 302. To accommodate the movement of the brackets 300, 302 with respect to one another, a second slot 318 is defined by the top bracket 300 and a third slot 504 is defined by the bottom bracket 302. A bolt 320 is disposed through the second and third slots 318, 504 to allow movement of the leg 108 along the second axis 124. A nut 322 may be used with the bolt 320 to secure the brackets 300, 302 in a set position.

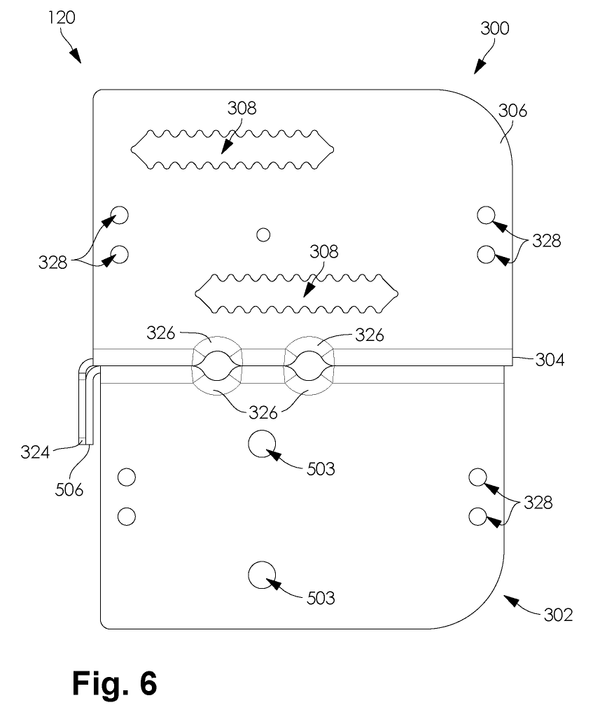

In the embodiment shown in FIGS. 2-6, the top bracket 120 may include a tab 324 extending from and generally perpendicular to the central panel 304. The bottom bracket 122 may also include a tab 506, as best seen in FIG. 5, extending from and generally perpendicular to the central panel 500. The tab 324 of the top bracket 120 defines the second slot 318 and the tab 506 of the bottom bracket 122 defines the third slot 504. The tab 324 of the upper bracket overlaps the tab 506, thus allowing movement of the top bracket 120 along the second axis 124, as best seen in FIG. 6.

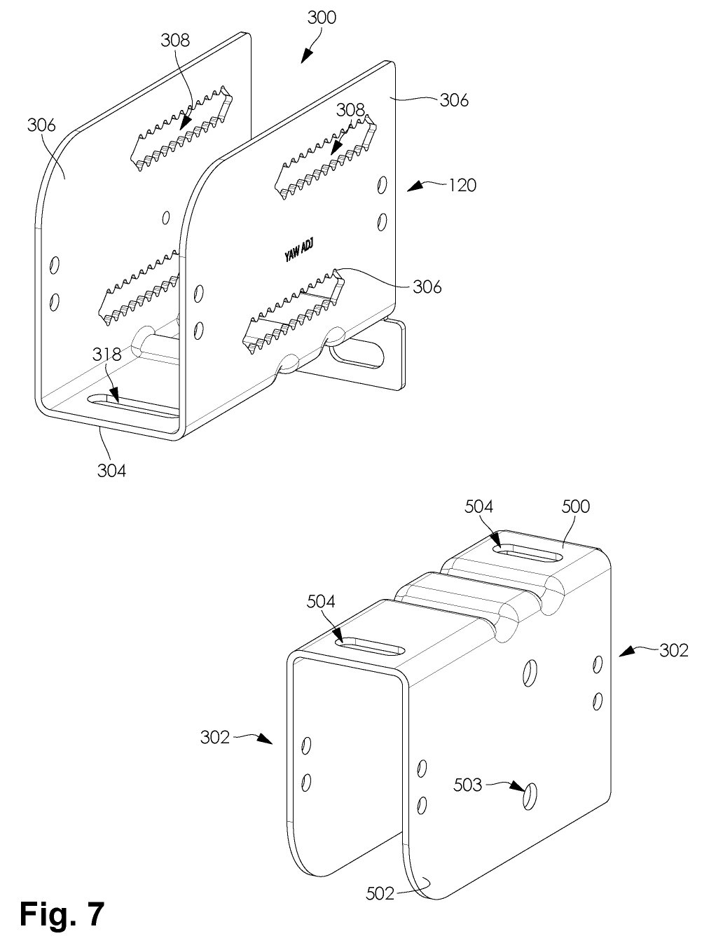

The second and third slots 318, 504 may additionally, or alternatively, be defined by the central panels 304, 500 of the top and bottom brackets 120, 122. For instance, as best seen in FIG. 7, the top and bottom brackets 120, 122 do not include the tabs 324, 506 extending from the central panels 304, 500. Instead, a pair of second slots 318 are defined by the central panel 304 of the top bracket 120 and a pair of third slots 504 are defined by the central panel 500 of the bottom bracket 122. Bolts (not shown) and nuts (not shown) may be used to secure the brackets 120, 122 together and allow movement of the brackets 120, 122 with respect to the second axis 124.

As can be seen in FIGS. 2-6, the top and bottom brackets 120, 122 may each include stiffening ribs 326. The central panels 304, 500 of the brackets 120, 122 may form the stiffening ribs 326, which serve to keep the side panels 306, 502 generally perpendicular to the respective central panels 304, 500.

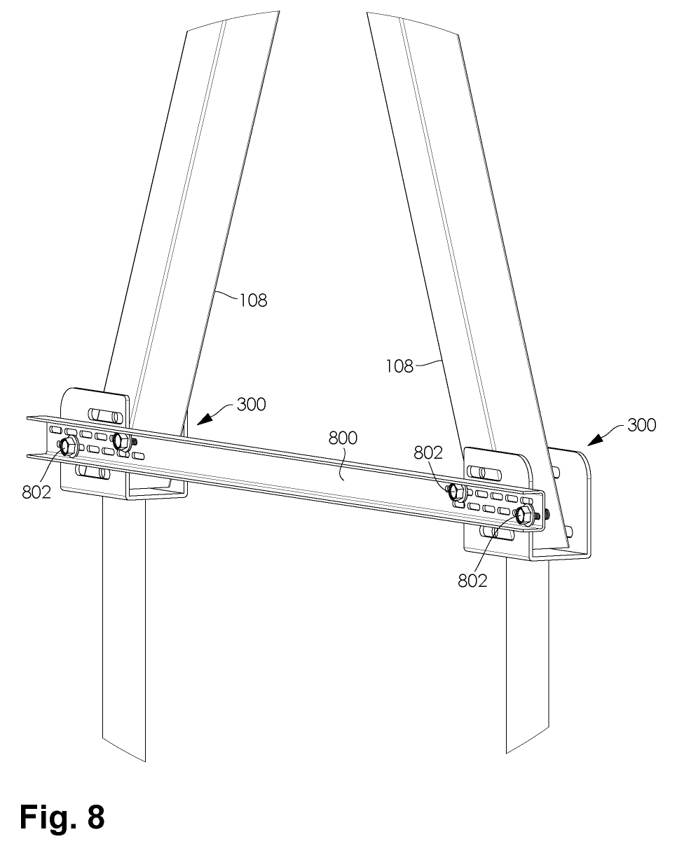

The side panels 306, 502 may also define a plurality of attachment holes 328, as best seen in FIGS. 3-7. In certain installation situations, the soil composition of the ground 116 may cause a situation where the loads (e.g., solar panels 100, torque tube 106, legs, 108, etc.) of the support structure 100 become laterally unbalanced. In these situations, a brace 800, shown in FIG. 8, may be attached to a plurality of side panels 306, 502 of separate alignment mechanisms 120 using, for example, lag screws 802.

The brace 800 provides lateral stability between adjacent support structures 100, distributing loads across multiple alignment mechanisms 120 to resist lateral displacement under unbalanced loading conditions, such as those arising from uneven soil composition. In certain embodiments, the brace 800 may be a rigid structural member, such as a steel channel or tube, extending between two or more adjacent alignment mechanisms 120. The attachment holes 328 may be arranged at varying positions along the height of the side panels 306, 502, allowing the brace 800 to be mounted at different elevations to accommodate varying installation configurations and ground conditions.

As will be appreciated from the foregoing description, the alignment mechanism 120 provides yaw adjustment of the leg 108 and mounting bracket 104 about a generally vertical axis by combining two independently operable adjustment mechanisms: lateral shifting of the top bracket 300 relative to the bottom bracket 302 via the second and third slots 318, 504, and fore-and-aft and angular positioning of the leg 108 via the serrated slots 308 and carriage bolt 310. Used individually or in combination, these mechanisms allow the installer to compensate for misalignment of the anchor 114 while maintaining the leg 108 and mounting bracket 104 within manufacturer-specified tolerances.

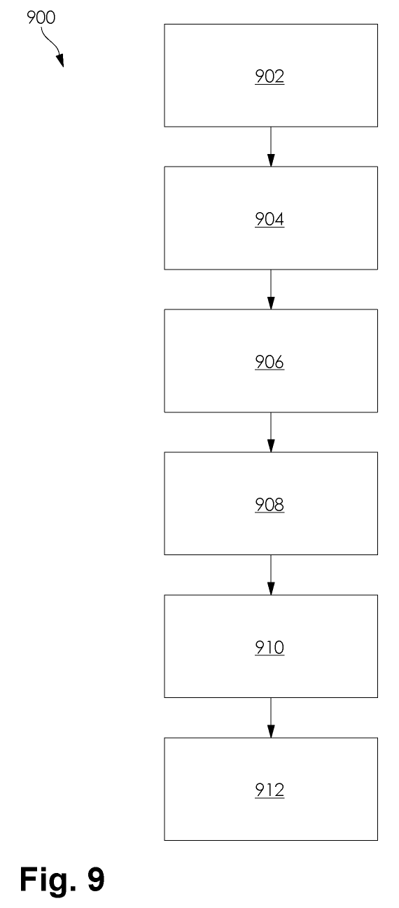

Referring now to FIG. 9, a method 900 of installing the alignment mechanism 120 to compensate for misalignment of the anchor 114 is shown. The method 900 may include a step 902 of providing the anchor 114 set in the ground 116 with the attachment end 118 protruding above the ground 116. The anchor 114 may be a ground screw driven into the ground 116 and may include an aperture formed through the attachment end 118 for receiving a fastener.

The method 900 may include a step 904 of securing the bottom bracket 302 to the attachment end 118 of the anchor 114. The apertures of the side panels 502 of the bottom bracket 302 may be aligned with the aperture of the attachment end 118, and the bolt 314 may be inserted through the aligned apertures and secured with the nut 316. At this stage, the bottom bracket 302 may be fixedly attached to the anchor 114.

The method 900 may include a step 906 of positioning the top bracket 300 against the bottom bracket 302 with the central panel 304 of the top bracket 300 abutting the central panel 500 of the bottom bracket 302 and with the side panels 306 of the top bracket 300 and the side panels 502 of the bottom bracket 302 extending in opposite directions away from one another. The second slot 318 of the top bracket 300 may be aligned with the third slot 504 of the bottom bracket 302, and the bolt 320 may be inserted through the aligned slots 318, 504 and loosely secured with the nut 322 to permit subsequent lateral adjustment of the top bracket 300 relative to the bottom bracket 302 along the second axis 124.

The method 900 may include a step 908 of connecting the second end 112 of the leg 108 to the top bracket 300. The holes defined by the leg 108 may be aligned with the slots 308 of the side panels 306 of the top bracket 300, and the carriage bolt 310 may be inserted through one slot 308, through the holes in the leg 108, and through the corresponding slot 308 on the opposite side panel 306. The nut 312 may be loosely secured to permit subsequent adjustment of the leg 108 along the first axis 122.

The method 900 may include a step 910 of adjusting the position of the leg 108 along the first axis 122 and the second axis 124 to achieve proper yaw alignment of the mounting bracket 104 relative to the anchor 114. The top bracket 300 may be shifted laterally relative to the bottom bracket 302 via the slots 318, 504 to correct lateral deviation of the anchor 114, and the carriage bolt 310 may be positioned along the serrated slot 308 to engage a desired serration corresponding to the desired fore-and-aft and angular position of the leg 108. The two adjustment mechanisms may be used individually or in combination depending on the nature and degree of misalignment of the anchor 114.

The method 900 may include a step 912 of tightening all fasteners to secure the alignment mechanism 120 in the aligned position. Once proper yaw alignment has been confirmed, the nut 322 of the bolt 320 and the nut 312 of the carriage bolt 310 may be fully tightened, fixing the top bracket 300 relative to the bottom bracket 302 and the leg 108 relative to the top bracket 300. The alignment mechanism 120 may thereby be secured in the corrected position, maintaining the leg 108 and mounting bracket 104 within the manufacturer-specified alignment tolerance.

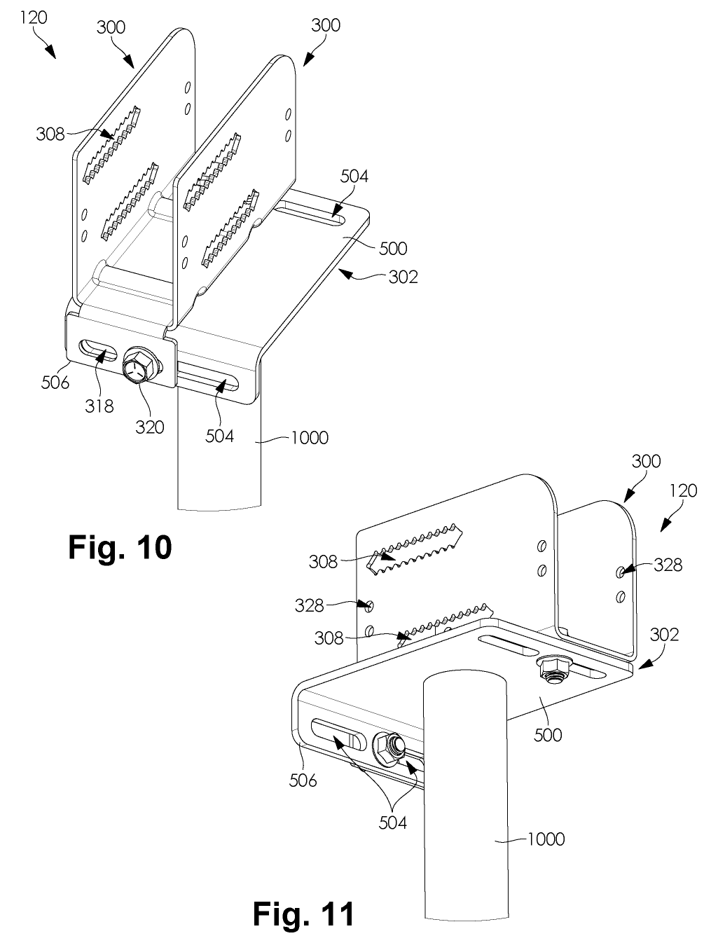

Referring now to FIG. 10 and 11, another exemplary embodiment includes the top bracket 300 and the bottom bracket 302. The top bracket 300 shown in FIGS. 10 and 11 is similar to those shown in FIGS. 3, 4 and 6. The bottom bracket 302 of FIGS. 10 and 11 includes the central panel 500. The bottom bracket 302 may also include the tab 506 extending from and generally perpendicular to the central panel 500. The tab 324 of the top bracket 120 defines the second slot 318 and the tab 506 of the bottom bracket 302 defines the third slot 1004. The tab 324 of the upper bracket overlaps the tab 506, thus allowing movement of the top bracket 120.

The exemplary embodiment shown in FIGS. 10 and 11 does not include side panels extending from the central panel 500. Instead, a pole 1000 is coupled to the central panel. For example, the pole 1000 may be welded to the bottom bracket 302. In one configuration, the pole 1000 may be separate from the anchor 114 and then attached to the anchor 114. In another configuration the pole 1000 and the anchor 114 may be the same element.

### EXAMPLES

The following examples demonstrate various installation scenarios for the alignment mechanism 120 and its ability to compensate for ground anchor misalignment across different spans and degrees of anchor deviation commonly encountered during solar tracker installation. The examples illustrate the system's capability to provide up to about three degrees of yaw adjustment in standard configurations, and up to about five degrees when using enlarged brackets.

### Example 1: Installation on Level Ground with Minor Misalignment.

In a first example, the alignment mechanism 120 was installed at a solar installation site with relatively level terrain where the anchor 114 had shifted approximately one inch laterally during installation due to variations in soil density, across a span of about 36 inches. Prior to installation of the alignment mechanism 120, the deviation of the anchor 114 from its intended position was measured and determined to fall within the adjustment range of the standard bracket assemblies. The bottom bracket 302 was first secured to the attachment end 118 of the anchor 114 by aligning the apertures of the side panels 502 with the corresponding aperture of the anchor 114 and inserting the bolt 314 therethrough, secured with the nut 316. The top bracket 300 was then positioned with its central panel 304 abutting the central panel 500 of the bottom bracket 302, with the side panels 306 and 502 extending in opposite directions, and the bolt 320 was loosely inserted through the aligned second and third slots 318, 504. The second end 112 of the leg 108 was then connected to the top bracket 300 by inserting the bolt 310 through the slots 308 of the side panels 306 and the holes of the leg 108, and loosely securing the nut 312. With both bolts 310, 320 loosely secured, the lateral adjustment capability of the slots 318, 504 was utilized to shift the top bracket 300 relative to the bottom bracket 302, compensating for the one-inch misalignment of the anchor 114 and achieving proper torque tube alignment within the manufacturer-specified tolerance of about three degrees. The carriage bolt 310 was engaged with the appropriate serration of the slot 308 to fix the fore-and-aft position of the leg 108, and all fasteners were then fully tightened to secure the assembly in the aligned position.

### Example 2: Installation with Significant Ground Anchor Deviation.

In a second example, the anchor 114 was installed in an area where subsurface rock formations caused the anchor to deviate approximately two inches from its intended position across a span of about 48 inches. The greater degree of misalignment in this installation required more deliberate use of both available adjustment mechanisms of the alignment mechanism 120. The bottom bracket 302 was secured to the attachment end 118 of the anchor 114 in the same manner as described in Example 1. The top bracket 300 was then positioned against the bottom bracket 302 and loosely secured through the aligned second and third slots 318, 504. The second end 112 of the leg 108 was connected to the top bracket 300 through the serrated slots 308, with the carriage bolt 310 loosely engaged to permit adjustment. The installer then utilized both the lateral adjustment provided by the central panel slots 318, 504 and the incremental fore-and-aft and angular adjustment provided by the serrated side panel slots 308 in combination to address the compound misalignment of the anchor 114. The top bracket 300 was shifted laterally relative to the bottom bracket 302 to correct the primary lateral deviation, and the carriage bolt 310 was repositioned along the serrated slot 308 to engage a serration corresponding to the desired angular position of the leg 108, providing the additional angular correction needed to bring the assembly within the manufacturer's three-degree specification. Once proper torque tube alignment was confirmed, all fasteners 310, 314, 320 were fully tightened to secure the assembly in the corrected position.

### Example 3: Installation with Enlarged Brackets for Extended Adjustment Range.

In a third example, enlarged bracket assemblies were utilized to accommodate an anchor 114 that had been installed with approximately three inches of misalignment across a span of about 60 inches, a degree of deviation exceeding the adjustment range of standard bracket assemblies. The enlarged bracket assemblies were configured identically to the standard assemblies described herein but incorporated extended central panel slots 318, 504 and extended serrated side panel slots 308, providing a greater range of lateral travel and angular adjustment than the standard brackets. The extended slots enabled yaw adjustment of up to about five degrees, sufficient to address the severe misalignment encountered at this installation site. The installation procedure followed the same sequence as described in Examples 1 and 2: the bottom bracket 302 was first secured to the anchor 114, the top bracket 300 was positioned against the bottom bracket 302 and loosely secured through the aligned central panel slots 318, 504, and the leg 108 was connected to the top bracket 300 through the extended serrated slots 308. The full range of both the lateral and angular adjustment mechanisms was utilized in combination to bring the leg 108 and mounting bracket 104 into proper yaw alignment. After final positioning was confirmed to be within the manufacturer's alignment specifications, all fasteners 310, 314, 320 were fully tightened to secure the assembly in the aligned position.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure.

In some example embodiments, well-known processes, well-known device structures, and well-known technologies are not described in detail. Equivalent changes, modifications and variations of some embodiments, materials, compositions and methods can be made within the scope of the present technology, with substantially similar results

What is claimed is:

1. A support structure for supporting a torque tube supporting a solar panel, comprising:
a mounting bracket for supporting the torque tube;
a leg extending between a first end and a second end with the first end coupled to the mounting bracket;
an anchor seated in the ground including an attachment end protruding above the ground; and
an alignment mechanism coupled to the second end of the leg and the attachment end of the anchor allowing for adjustment of the second end of the leg along at least one axis generally parallel to the ground.

2. The support structure of claim 1, wherein the alignment mechanism allows for movement of the second end of the leg along a first axis generally parallel to the ground and a second axis generally parallel to the ground and generally perpendicular to the first axis.

3. The support structure of claim 1, wherein the alignment mechanism comprises:
a top bracket having a central panel and side panels extending from opposite sides of the central panel, the top bracket coupled to the leg;
a bottom bracket having a central panel and side panels extending from opposite sides of the central panel, the bottom bracket coupled to the anchor;
wherein the central panel of the top bracket abuts the central panel of the bottom bracket; and
wherein the top bracket defines at least one slot accommodating at least one bolt coupled to the leg and allowing movement of the second end of the leg along at least one axis generally parallel to the ground.

4. The support structure of claim 3, wherein the at least one slot is defined by at least one of the side panels of the top bracket.

5. The support structure of claim 4, wherein the at least one slot includes a first slot defined by one of the side panels of the top bracket and a second slot defined by the other of the side panels of the top bracket and wherein the leg defines a first hole therethrough and wherein the at least one bolt is disposed through the first slot, the first hole, and the second slot.

6. The support structure of claim 4, wherein the at least one slot includes serrations and the at least one bolt is a carriage bolt having a portion with a generally rectangular cross section such that the portion of the carriage bolt with a generally rectangular cross section engages with the serrations of the at least one slot.

7. The support structure of claim 3, wherein the at least one slot is defined by the central panel of the top bracket.

8. The support structure of claim 3, further comprising a tab extending generally perpendicular to the central panel of the top bracket and wherein the at least one slot is defined by the tab.

9. An alignment mechanism for alignment of a support structure of a torque tube with a ground anchor, the support structure including a leg, the alignment mechanism comprising:
a top bracket configured to be coupled to the leg;
a bottom bracket configured to be coupled to the ground anchor;
the top bracket defining a first slot;
a first bolt disposed through the first slot and connectable to the leg for allowing the leg to be adjusted along a first axis;
the top bracket defining a second slot;
the bottom bracket defining a third slot; and
a second bolt disposed through the second slot and the third slot and allowing the leg to be adjusted along a second axis generally perpendicular to the first axis.

10. The alignment mechanism of claim 9, wherein the top bracket includes a central panel and a side panel extending generally perpendicular from the central panel, and wherein the first slot is defined by the side panel.

11. The alignment mechanism of claim 10, wherein the second slot is defined by the central panel.

12. The alignment mechanism of claim 10, wherein the top bracket includes a tab extending generally perpendicular to the central panel of the top bracket and wherein the second slot is defined by the tab.

13. The alignment mechanism of claim 12, wherein the bottom bracket includes a central panel coupled to the central panel of the top bracket and wherein the bottom bracket includes a tab extending generally perpendicular to the central panel and wherein the third slot is defined by the tab.

14. A method of installing an alignment mechanism to compensate for misalignment of a ground anchor, the method comprising:
securing a bottom bracket to an attachment end of the anchor, the bottom bracket having a central panel and side panels extending from opposite sides of the central panel;
positioning a top bracket against the bottom bracket with a central panel of the top bracket abutting the central panel of the bottom bracket and with the side panels of the top bracket and the side panels of the bottom bracket extending in opposite directions away from one another;
connecting a second end of a leg to the top bracket through at least one slot defined by the top bracket;
adjusting a position of the leg along at least one axis generally parallel to the ground to achieve alignment of the leg relative to the anchor; and
tightening fasteners to secure the alignment mechanism in the aligned position.

15. The method of claim 14, wherein adjusting the position of the leg comprises adjusting the leg along a first axis by sliding a bolt through a slot defined by a side panel of the top bracket and adjusting the leg along a second axis generally perpendicular to the first axis by sliding a bolt through a slot defined by the top bracket and a slot defined by the bottom bracket.

16. The method of claim 14, wherein securing the bottom bracket to the attachment end of the anchor comprises aligning apertures of the side panels of the bottom bracket with an aperture of the attachment end of the anchor and inserting a fastener through the aligned apertures.

17. The method of claim 14, wherein connecting the second end of the leg to the top bracket comprises inserting a carriage bolt through a slot defined by one side panel of the top bracket, through holes defined by the leg, and through a corresponding slot defined by the opposite side panel of the top bracket.

18. The method of claim 17, wherein the slot defined by the side panel of the top bracket defines serrations and wherein adjusting the position of the leg comprises engaging the carriage bolt with a desired serration of the slot to achieve a desired fore-and-aft and angular position of the leg.

19. The method of claim 14, wherein adjusting the position of the leg comprises adjusting the leg to achieve yaw alignment of up to about three degrees using standard bracket assemblies.

20. The method of claim 14, wherein adjusting the position of the leg comprises adjusting the leg to achieve yaw alignment of up to about five degrees using enlarged bracket assemblies having extended slots.
